(19) United States
(12) Patent Application Publication
(10) Pub. No.: US 2021/0326760 A1
(43) Pub. Date: Oct. 21, 2021

(54) LEARNING DEVICE, LEARNING METHOD, AND PREDICTION SYSTEM

(71) Applicant: NIPPON TELEGRAPH AND TELEPHONE CORPORATION, Tokyo (JP)

(72) Inventors: Atsutoshi KUMAGAI, Musashino-shi, Tokyo (JP); Tomoharu IWATA, Musashino-shi, Tokyo (JP)

(73) Assignee: NIPPON TELEGRAPH AND TELEPHONE CORPORATION, Tokyo (JP)

(21) Appl. No.: 17/270,054

(22) PCT Filed: Aug. 23, 2019
(86) PCT No.: PCT/JP2019/033186

§ 371 Date: Feb. 22, 2021

(30) Foreign Application Priority Data
Aug. 23, 2018 (JP) 2018-156667

(51) Int. Cl. G06N 20/00; G06K 9/62

(52) U.S. Cl. CPC G06N 20/00; G06K 9/6256; G06K 9/6232

(57) ABSTRACT

A learning device (10) receives an input of labeled data of a plurality of source domains relevant to a target domain and learns a supervised model predictor using information unique to each domain in the labeled data of the plurality of source domains. Further, the prediction device (20) receives an input of unlabeled data of a target domain, outputs a supervised model suitable for the target domain using the learned supervised model predictor, performs prediction of the unlabeled data of the target domain using the supervised model, and output a prediction result.

### TECHNICAL FIELD

The present invention relates to a learning device, a learning method, and a prediction system.

### BACKGROUND ART

In machine learning, a generation distribution of samples may differ between when a model (for example, a classifier) is learned and when testing of a model (prediction using the model) is performed. The generation distribution of the samples describes a probability of generation of each sample. For example, a generation probability of a certain sample may change from 0.3 when the model is learned to 0.5 when the testing of the model is performed.

For example, in the case of spam mail classification, a generation distribution of spam mail changes with time because a spam mail creator creates spam mail with a new feature every day in an attempt to get past a classification system. Further, in the case of image classification, even when the same object is imaged, a generation distribution of an image greatly differs depending on a photographing device (a digital single-lens reflex camera, a feature phone, or the like) or a photographing environment (an intensity of a light source, a background, or the like).

In such a case, when an ordinary supervised learning scheme is used, a problem is caused in that performance thereof greatly deteriorates. Here, the ordinary supervised learning scheme is a scheme for learning a relationship between a sample and a label based on a set of “a set of a sample and its attributes (labels)” (this is called labeled data). By learning the relationship between the sample and the labels, when a sample with unknown labels is given, the labels of the sample can be predicted. For example, when the sample is a newspaper article, “politics”, “economy”, “sports”, or the like can be considered as labels. A set of samples to which no labels are imparted is called unlabeled data.

Hereinafter, a domain with a task to be solved is called a target domain, and a domain relevant to the target domain is called a source domain. According to the above description, a domain to which data at the time of testing belongs is a target domain, and a domain to which data at the time of learning belongs is a source domain.

When a large amount of labeled data of a target domain is obtained, it is best to use the data to learn the model. However, it is difficult for sufficient labeled data of the target domain to be secured in many applications. Thus, many schemes with which test data can be accurately predicted even when generation distributions of the data at the time of learning and testing differ, by using, for learning, unlabeled data of the target domain with a relatively low collection cost, in addition to the labeled data of the source domain, have been proposed.

However, in some actual problems, it may be difficult for data of the target domain to be used for learning. For example, with the spread of Internet of Things (IoT) in recent years, cases in which complex processing (prediction) such as voice recognition or image recognition is performed on an IoT device are increasing. Because IoT devices do not have sufficient calculation resources, it is difficult for burdensome learning to be performed on such terminals even when the data of the target domain can be acquired.

Further, cyber attacks on IoT devices are rapidly increasing, but there are various types of IoT devices (for example, cars, TVs, and smartphones; features of data differ depending on types of vehicles), and new IoT devices are released into the world one after another, and thus high-cost learning is performed each time a new IoT device (target domain) appears, making it impossible to deal with cyber attacks immediately.

Further, in a personalized service such as an email system, data of a user (a target domain) cannot be used for learning without permission from the user, for protection of personal information of the user.

A scheme for learning a supervised model suitable for a target domain using “only” labeled data of a plurality of source domains has been proposed (called Zero-shot domain adaptation). Because data in a target domain is not used at the time of learning in Zero-shot domain adaptation, the Zero-shot domain adaptation can also be applied in the case described above. In Zero-shot domain adaptation of the related art, there are the following two approaches.

In one of the approaches, when information (for example, feature expression) is common to a plurality of source domains, it is assumed that the information can be used commonly by target domains, and a domain-independent supervised model is learned using only information that can be commonly used by a plurality of source domains. In the target domain, prediction is performed using the supervised model (see Non Patent Literature 1).

In the other of the approaches, some auxiliary information (time information, device information, or the like) representing features of each domain is used in order to predict a supervised model unique to a target domain, rather than the domain-independent supervised model. A function that receives auxiliary information as an input and outputs a supervised model is learned from a plurality of source domains, such that a unique supervised model suitable for the target domain can be predicted when the auxiliary information of the target domain is given (See Non Patent Literature 2).

### CITATION LIST

### Non Patent Literature

Non Patent Literature 1: Muhammad Ghifary, W. Bastiaan Kleijn, Mengjie Zhang, David Balduzzi, “Domain Generalization for Object Recognition with multi-task autoencoders”, ICCV, 2015.
Non Patent Literature 2: Yongxin Yang & Timothy M. Hospedales, “A UNIFIED PERSPECTIVE ON MULTI-DOMAIN AND MULTI-TASK LEARNING”, ICLR, 3852015.

### SUMMARY OF THE INVENTION

### Technical Problem

However, the related art has a problem that it may not be possible to obtain a highly accurate supervised model suitable for the target domain. For example, in the case of a technology described in Non Patent Literature 1 or the like, information common to each domain is used, but information unique to each domain is ignored. Thus, an information loss occurs, and a supervised learning model that can accurately predict data of the target domain is likely to be unable to be learned.

Further, for example, in the case of a technology described in Non Patent Literature 2 or the like, it can be expected that no information loss will occur because the supervised model unique to each domain is predicted using the auxiliary information representing the features of the domain. However, auxiliary information cannot be obtained in all actual problems. When such auxiliary information cannot be obtained, there is a problem that the technology cannot be applied in the first place.

### Means for Solving the Problem

In order to solve the above-described problems and achieve the object, a learning device of the present invention is a model learning device for learning a model predictor through supervised learning, the model learning device including: a learning data input unit configured to receive an input of labeled data of a plurality of source domains, to which training data for the supervised learning belongs, relevant to a target domain to which prediction target data of the model predictor belongs; and a learning unit configured to learn the model predictor using information unique to each domain in the labeled data of the plurality of source domains input by the learning data input unit.

Further, a learning method of the present invention is a learning method executed by a model learning device for learning a model predictor through supervised learning, the learning method including: receiving an input of labeled data of a plurality of source domains, to which training data for the supervised learning belongs, relevant to a target domain to which prediction target data of the model predictor belongs; and learning the model predictor using information unique to each domain in the labeled data of the plurality of source domains input in the receiving.

Further, a prediction system of the present invention is a prediction system including a model learning device configured to learn a model predictor through supervised learning, and a prediction device configured to perform prediction of prediction target data using the model predictor, wherein the model learning device includes a learning data input unit configured to receive an input of labeled data of a plurality of source domains, to which training data for the supervised learning belongs, relevant to a target domain to which the prediction target data of the model predictor belongs; and a learning unit configured to learn the model predictor using information unique to each the plurality of source domains in the labeled data of the plurality of source domains input by the learning data input unit, and the prediction device includes a data input unit configured to receive an input of unlabeled data of the target domain; a prediction unit configured to output a supervised model suitable for the target domain using the model predictor learned by the learning unit and perform prediction of the unlabeled data of the target domain received by the data input unit, using the supervised model; and an output unit configured to output a prediction result predicted by the prediction unit.

### Effects of the Invention

According to the present invention, it is possible to prevent information loss and obtain a highly accurate supervised model suitable for a target domain even when auxiliary information cannot be used.

### BRIEF DESCRIPTION OF DRAWINGS

FIG. 1 is a diagram illustrating an overview of model learning in a prediction system according to a first embodiment.

FIG. 2 is a diagram illustrating an example of a configuration of a prediction system according to the first embodiment.

FIG. 3 is a flowchart illustrating an example of a processing procedure of a learning device in FIG. 2.

FIG. 4 is a flowchart illustrating an example of a processing procedure of the prediction device in FIG. 2.

FIG. 5 is a diagram illustrating a computer that executes a prediction program.

### DESCRIPTION OF EMBODIMENTS

Hereinafter, embodiments of a learning device, a learning method, and a prediction system according to the present application will be described in detail with reference to the drawings. The learning device, the learning method, and the prediction system according to the present application are not limited by the embodiments.

### First Embodiment

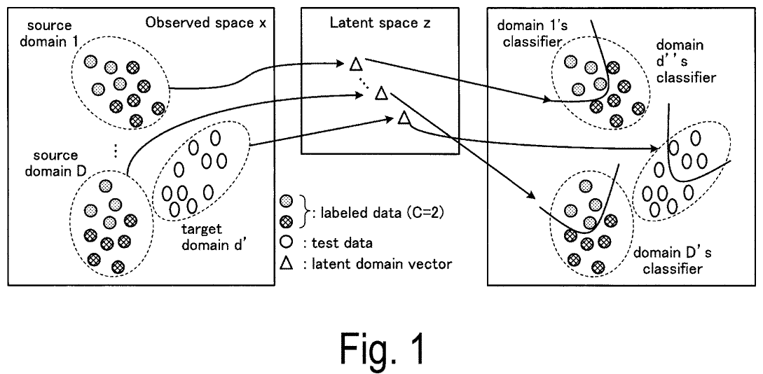

Hereinafter, a first embodiment of the present invention will be described with reference to the drawings. First, an overview of model learning in a prediction system (a system) of the first embodiment will be described with reference to FIG. 1.

Hereinafter, a model is, for example, a prediction model of prediction target data (test data), such as a classifier that predicts a label of a sample of the test data. Further, learning data that is used for creation (learning) of a model is training data such as the labeled data.

Further, in the following description, a target domain is a domain having a task to be solved, and a source domain differs from the target domain, but indicates a relevant domain. For example, when the task to be solved in the target domain is classification of content of newspaper articles, the target domain is a set of newspaper articles, and the source domain is, for example, a set of social networking service (SNS) statements. This is because newspapers and SNS are similar in terms of Japanese sentences, although there are differences in word usage and the like, and SNS statements are highly likely to be able to be also effectively utilized for classification of newspaper articles. Further, in the following description, it is assumed that training data such as labeled data is data belonging to the source domain and the test data is data belonging to the target domain.

The prediction system according to the first embodiment estimates a latent domain vector (a center diagram in FIG. 1) indicating a feature of a domain from a sample set of each domain (a left diagram in FIG. 1), and outputs a classifier from the latent domain vector (a right diagram of FIG. 1). The prediction system of the first embodiment can learn the above relationship using labeled data of a plurality of source domains to immediately output a classifier suitable for the target domain without performing learning when a sample set of the target domain is given.

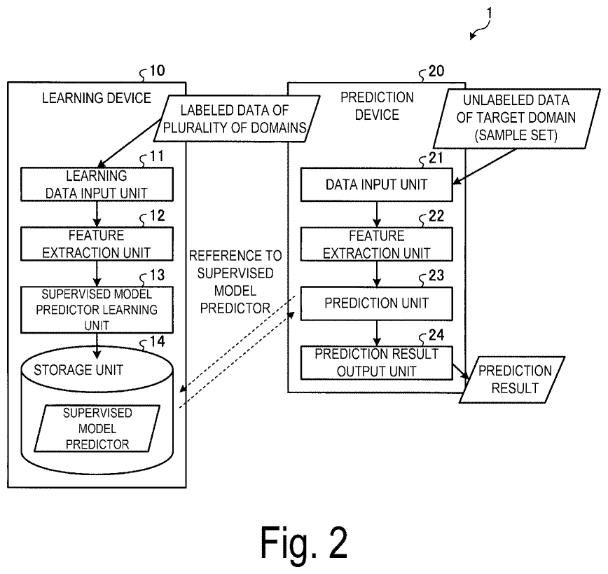

Next, an example of a configuration of the prediction system 1 according to the first embodiment will be described with reference to FIG. 2. Hereinafter, an example in which training data that is used by the learning device 10 is the labeled data, and the prediction device 20 predicts a label of a sample of the test data will be described.

The prediction system 1 predicts a supervised model suitable for the target domain without using auxiliary information of the target domain using only labeled data of the plurality of the source domains given at the time of learning and the unlabeled data of the target domain given at the time of prediction. The prediction system 1 includes, for example, the learning device 10 and the prediction device 20, as illustrated in FIG. 2. The learning device 10 and the prediction device 20 may be realized by one device having functions of both instead of being separate devices.

The learning device 10 learns a supervised model predictor (function) that outputs the supervised model specific to a domain from a sample set of each domain using the labeled data of the plurality of source domains.

The learning device 10 includes a learning data input unit 11, a feature extraction unit 12, a supervised model predictor learning unit 13, and a storage unit 14.

The learning data input unit 11 receives an input of the learning data. Specifically, the learning data input unit 11 receives an input of the labeled data of the plurality of source domains, among the source domains to which the training data for supervised learning belongs, relevant to the target domain to which the prediction target data of the model predictor belongs.

The labeled data is a set of pairs of a sample and attribute information (labels) of the sample. For example, when the sample is text, content (economy, politics, sports, or the like) represented by the text can be considered as labels. On the other hand, the unlabeled data is a set of samples to which no labels are imparted. In the above example, a set of only text corresponds to unlabeled data.

The feature extraction unit 12 extracts a feature quantity of the data. For example, the feature extraction unit 12 converts the labeled data of the source domain input by the learning data input unit 11 to a set of a feature vector and a label.

Here, the feature vector is obtained by expressing a feature of necessary data by an n-dimensional number vector. For conversion to the feature vector, a method generally used in machine learning is used. For example, when data is text, a scheme based on morphological analysis, a scheme based on n-gram, a scheme based on a delimiter, or the like can be considered. The label is converted to a label value indicating the label.

The supervised model predictor learning unit 13 learns a “supervised model predictor” that outputs a supervised model suitable for the domain from the sample set of each domain using the labeled data of the plurality of source domains after feature extraction. Any model may be used as the supervised model. That is, for example, a classification model is used when the label is a discrete value, and a regression model is used when the label is a continuous value.

The storage unit 14 stores the supervised model predictor learned by the supervised model predictor learning unit 13.

The prediction device 20 predicts a supervised learning model suitable for the target domain when the sample set of the target domain is given by using a learned model. The prediction device 20 includes a data input unit 21, a feature extraction unit 22, a prediction unit 23, and a prediction result output unit 24.

The data input unit 21 receives an input of the unlabeled data of the target domain. Specifically, the data input unit 21 receives an input of the unlabeled data (sample set) of the target domain that is a prediction target.

The feature extraction unit 22 extracts a feature quantity of the unlabeled data of the target domain. That is, the feature extraction unit 22 converts a sample that is a prediction target to a feature vector. The extraction of the feature quantity here is performed by the same procedure as the feature extraction unit 12 of the learning device 10.

The prediction unit 23 outputs the supervised model suitable for the target domain using the supervised model predictor learned by the learning device 10, and performs prediction of the unlabeled data of the target domain using the supervised model. Specifically, the prediction unit 23 outputs the supervised model from the sample set using the supervised model predictor learned by the learning device 10. The prediction unit 23 performs prediction of each sample using the obtained supervised model. The prediction result output unit 24 outputs a prediction result (for example, a label of each sample) of the prediction unit 23.

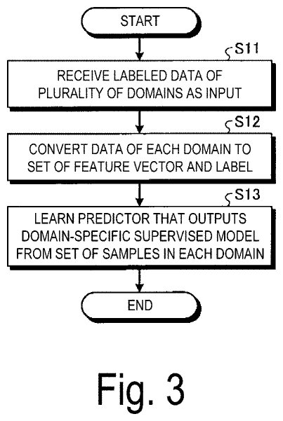

Next, a processing procedure of the learning device 10 will be described with reference to FIG. 3. First, the learning data input unit 11 of the learning device 10 receives the labeled data (data of the source domain) of a plurality of domains as an input (S11). The feature extraction unit 12 then converts the data of each domain received in S11 to a set of a feature vector and a label (S12).

After S12, the supervised model predictor learning unit 13 learns the “the supervised model predictor” that outputs a domain-specific supervised model from the sample set of each domain (S13).

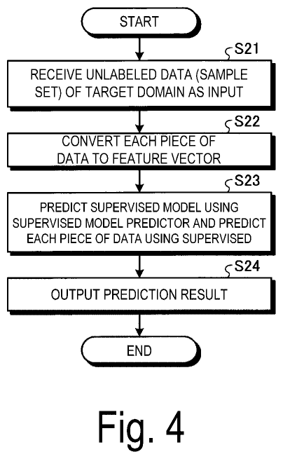

Next, a processing procedure of the prediction device 20 will be described with reference to FIG. 4. First, the data input unit 21 of the prediction device 20 receives the unlabeled data (sample set) of the target domain as an input (S21). Then, the feature extraction unit 22 converts each piece of data (test data) received in S21 to a feature vector (S22). The prediction unit 23 predicts the supervised model using the supervised model predictor learned by the learning device 10, and predicts each piece of data using the model (S23). The prediction result output unit 24 outputs a result of the prediction in S23 (prediction result) (S24).

Next, an example of a learning method in the supervised model predictor learning unit 13 will be described in detail. Here, although a case in which a sample label classification problem (a problem when a label value is the discrete value) is treated as a task of the target domain will be described as an example, the present invention can be applied to any supervised learning for a regression problem, a ranking problem, or the like.

First, labeled data of a d-th source domain is defined as shown in Equation 1 below. Here, x_{dn} is defined as an M-dimensional feature vector of an n-th sample in the d-th source domain.

[Math. 1]

[symbol]

:={x_{dn},y_{dn}}ₙ₌₁^{N}^{_{d}}

Further, a label of an n-th sample is defined as shown in Equation 2 below.

[Math. 2]

y_{dn}∈{0, . . . ,C}

Further, unlabeled data (sample) set of the d-th source domain is defined as shown in Equation 3 below.

[Math. 3]

X_{d}:={x_{dn}}ₙ₌₁^{N}^{_{d}}

The purpose here is to construct a predictor that predicts a domain-specific classifier for any domain when labeled data of D types of the source domains is given at the time of learning. The labeled data of the D types of the source domains is defined as shown in Equation 4 below.

[Math. 4]

[symbol]

=∪_{d=1}^{D} [symbol] _{d}

In the present invention, the predictor is constructed using a probabilistic model. First, it is assumed that each domain d has a k-dimensional latent variable z=. Hereinafter, this latent variable will be referred to as a latent domain vector. This latent domain vector is assumed to be generated from a standard Gaussian distribution p(z)=N(z|0,1). It is assumed that a label ydn of a sample x_{dn} of each domain is generated by p_{θ}(y_{dn}|x_{dn}, z_{d}) using a latent domain vector z_{d}. Here, θ is a parameter. Specifically, a c-th element before normalization of p_{θ}(y_{dn}|x_{dn}, z_{d}) is expressed as Equation (1) below.

[Math. 5]

f_{c}(x_{dn},z_{d}):=h(x_{dn})·g_{c}(z_{d}),h(x_{dn})∈ [symbol] ^{J},g_{c}(z_{d})∈ [symbol] ^{J} (1)

Here, h and g_{c} are any neural networks. The above equation can express various classifiers (decision boundaries) by changing the latent vector z_{d}. That is, it is possible to obtain a classifier suitable for each domain by appropriately estimating z_{d} for each domain.

The logarithmic marginal likelihood of the present invention is expressed as Equation (2) below.

$$\begin{matrix}[ Math . 6 ] & \\ ln p ( & ( 2 )\end{matrix}$$

When this logarithmic marginal likelihood can be calculated analytically, a posterior distribution of the latent domain vector is obtained, but this calculation is impossible. Thus, the posterior distribution of the latent domain vector is approximated by Equation (3) below.

[Math. 7]

q_{ϕ}(z_{d}|X_{d})= [symbol] (z_{d}|μ_{ϕ}(X_{d}),σ_{ϕ}²(X_{d})), (3)

Here, a mean function and a covariance function are any neural networks, and φ is a parameter thereof. It can be expected that the latent domain vector suitable for the domain can be output when only a sample set of the domain is given by modeling the posterior distribution above. The mean function and the covariance function are specifically expressed by an architecture in the form of Equation (4) below.

$$\begin{matrix}[ Math . 8 ] & \\ τ ( {X}_{d} ) = ρ ( \frac{1}{{N}_{d}} {\sum }_{n = 1}^{{N}_{d}} η ( {x}_{dn} ) ) & ( 4 )\end{matrix}$$

Here, ρ and η are any neural networks. Defining the architecture in this way allows an output thereof to be always returned as a constant output regardless of an order of the sample sets (that is, the set can be taken as an input). Further, an output of η is averaged such that a result can be stably output even when the numbers of samples differ in the respective domains.

A lower limit of the logarithmic marginal likelihood is expressed as Equation (5) below by using the approximate posterior distribution described above.

$$\begin{matrix}[ Math . 9 ] & \\ ln p ( ) ≧ ( ; θ , ϕ ) := {\sum }_{d = 1}^{D} [ - {D}_{KL} ( {q}_{ϕ} ( {z}_{d} \vert {X}_{d} ) ‖ p ( {z}_{d} ) ) + {q ϕ ( {z}_{d} \vert {X}_{d} )}_{} [ {\sum }_{n = 1}^{{N}_{d}} ln {p}_{θ} ( {𝓎}_{dn} \vert {x}_{dn} , {z}_{d} ) ] ] & ( 5 )\end{matrix}$$

This lower limit can be approximated in a computable form as shown in Equation (6) below by using reparametrization trick. A desired predictor can be obtained by maximizing the lower limit L for the parameters θ and φ. This maximization can be executed in a usual method using a stochastic gradient descent (SGD).

$$\begin{matrix}[ Math . 10 ] & \\ ( ; θ , ϕ ) \approx {\sum }_{d = 1}^{D} [ - {D}_{KL} ( {q}_{ϕ} ( {z}_{d} \vert {X}_{d} ) ‖ p ( {z}_{d} ) ) + \frac{1}{L} {\sum }_{ℓ = 1}^{L} {\sum }_{n = 1}^{{N}_{d}} ln {p}_{θ} ( {𝓎}_{dn} \vert {x}_{dn} , {z}_{d}^{( ℓ )} ) ] & ( 6 )\end{matrix}$$

Here, [symbol] =μ_{ϕ}(X_{d})+ [symbol] σ_{ϕ}(X_{d}), where [symbol] ˜N(0,I).

Further, hereinafter, a prediction phase will be described below using a specific example dealt with in the description of the learning phase. A sample set of the target domain d′ is defined as shown in Equation 11 below.

[Math. 11]

X_{d′}:={x_{d′n}}ₙ₌₁^{N}^{_{d′}}

When the sample set of the target domain d′ is given, the label of each sample is predicted by Equation (7) below.

$$\begin{matrix}[ Math . 12 ] & \\ p ( {𝓎}_{{d}^{′} n} \vert {x}_{{d}^{′} n} ) = \int {p}_{θ} ( {𝓎}_{{d}^{′} n} \vert {x}_{{d}^{′} n} , {z}_{{d}^{′}} ) {q}_{ϕ} ( {z}_{{d}^{′}} \vert {X}_{{d}^{′}} ) {dz}_{{d}^{′}} \approx \frac{1}{L} {\sum }_{ℓ = 1}^{L} {p}_{θ} ( {𝓎}_{{d}^{′} n} \vert {x}_{{d}^{′} n} , ) , \\ Here , = {μ}_{ϕ} ( {X}_{d} ) + {ϵ}^{( ℓ )} {σ}_{ϕ} ( {X}_{d} ) , where \sim 𝒩 ( 0 , I ) . \\ & ( 7 )\end{matrix}$$

### Effects of First Embodiment

As described above, the learning device 10 of the prediction system 1 according to the first embodiment receives the input of the labeled data of the plurality of source domains relevant to the target domain and learns the supervised model predictor using the information unique to each domain in the labeled data of the plurality of source domains. Further, the prediction device 20 receives the input of the unlabeled data of the target domain, outputs the supervised model suitable for the target domain using the learned supervised model predictor, performs prediction of the unlabeled data of the target domain using the supervised model, and output a prediction result. Thus, it is possible to prevent information loss and, obtain a highly accurate supervised model suitable for the target domain even when the auxiliary information cannot be used.

That is, the prediction system 1 predicts the supervised model specific to each domain using information specific to each domain. Thus, the prediction system 1 can predict the supervised model suitable for the target domain without losing necessary information. Further, because the prediction system 1 can predict the supervised model unique to the target domain without using the auxiliary information, the prediction system 1 can accurately predict the supervised model even in an environment in which the auxiliary information cannot be used.

Thus, because the prediction system 1 prevents an information loss by using information unique to each domain and does not assume the presence of the auxiliary information, it is possible to obtain a highly accurate supervised model suitable for the target domain against a wide range of actual problems including cases in which auxiliary information cannot be used.

System Configuration or the Like

Further, the respective components of the devices, which have been illustrated, are functional and conceptual ones, and are not necessarily physically configured as illustrated. That is, a specific form of distribution and integration of the respective devices is not limited to the illustrated one, and all or a portion thereof can be configured to be functionally or physically distributed and integrated in any units, according to various loads, use situations, and the like. Further, all or some of processing functions performed by each device may be realized by a CPU and a program that is analyzed and executed by the CPU, or may be realized as hardware based on a wired logic.

Further, all or some of the processes described as being performed automatically among the respective processes described in the embodiment can be performed manually, or all or some of the processes described as being performed manually can be performed automatically using a known method. In addition, information including the processing procedures, control procedures, specific names, and various types of data or parameters illustrated in the aforementioned literatures or drawings can be arbitrarily changed unless otherwise specified.

Program

Further, a program that realizes a function of the prediction system 1 described in each of the above embodiments can be implemented by being installed in a desired information processing device (a computer). For example, the information processing device is caused to execute the above program provided as package software or online software such that the information processing device can be caused to function as the prediction system 1. The information processing device referred to here includes a desktop or notebook personal computer. Further, a mobile communication terminal such as a smartphone, a mobile phone, a personal handyphone system (PHS), and a personal digital assistant (PDA), and the like, in addition to the above, are included in a category of the information processing device. Further, the function of the prediction system 1 may be implemented in a cloud server.

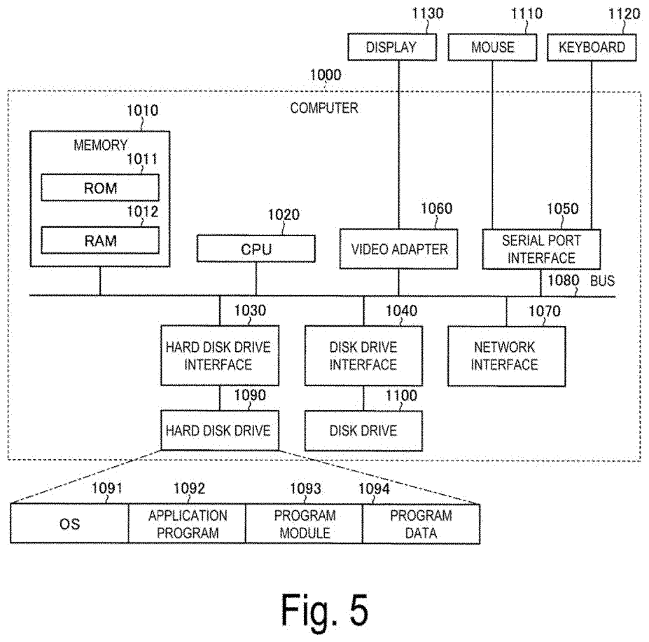

An example of a computer that executes the above program (prediction program) will be described with reference to FIG. 5. A computer 1000 includes, for example, a memory 1010, a CPU 1020, a hard disk drive interface 1030, a disc drive interface 1040, a serial port interface 1050, a video adapter 1060, and a network interface 1070, as illustrated in FIG. 5. These units are connected by a bus 1080.

The memory 1010 includes a read only memory (ROM) 1011 and a random access memory (RAM) 1012. The ROM 1011 stores, for example, a boot program, such as a basic input output system (BIOS). The hard disk drive interface 1030 is connected to a hard disk drive 1090. The disc drive interface 1040 is connected to a disc drive 1100. A detachable storage medium such as a magnetic disk or an optical disc, for example, is inserted into the disc drive 1100. A mouse 1110 and a keyboard 1120, for example, are connected to the serial port interface 1050. A display 1130, for example, is connected to the video adapter 1060.

Here, the hard disk drive 1090 stores, for example, an OS 1091, an application program 1092, a program module 1093, and program data 1094, as illustrated in FIG. 5. The various types of data or information described in the above embodiments are stored in, for example, the hard disk drive 1090 or the memory 1010.

The CPU 1020 reads the program module 1093 or the program data 1094 stored in the hard disk drive 1090 into the RAM 1012, as necessary, and executes each of the above-described procedures.

The program module 1093 or the program data 1094 relevant to the above prediction program is not limited to being stored in the hard disk drive 1090 and, for example, may be stored in a detachable storage medium and read by a central processing unit (CPU) 1020 via the disc drive 1100 or the like. Alternatively, the program module 1093 or the program data 1094 relevant to the program may be stored in another computer connected via a network such as a local area network (LAN) or a wide area network (WAN) and read by the CPU 1020 via the network interface 1070.

### REFERENCE SIGNS LIST

1 Prediction system
10 Learning device
11 Learning data input unit
12, 22 Feature extraction unit
13 Supervised model predictor learning unit
14 Storage unit
20 Prediction device
21 Data input unit
23 Prediction unit
24 Prediction result output unit

1. A model learning device for learning a model predictor through supervised learning, the model learning device comprising:
learning data input circuitry configured to receive an input of labeled data of a plurality of source domains, to which training data for the supervised learning belongs, relevant to a target domain to which prediction target data of the model predictor belongs; and
learning circuitry configured to learn the model predictor using information unique to each domain in the labeled data of the plurality of source domains input by the learning data input circuitry.

2. The model learning device according to claim 1, further comprising
feature extraction circuitry configured to extract a feature quantity of the labeled data of the source domain input by the learning data input circuitry,
wherein the learning circuitry learns the model predictor using the feature quantity extracted by the feature extraction circuitry.

3. A learning method executed by a model learning device for learning a model predictor through supervised learning, the learning method comprising:
receiving an input of labeled data of a plurality of source domains, to which training data for the supervised learning belongs, relevant to a target domain to which prediction target data of the model predictor belongs; and
learning the model predictor using information unique to each domain in the labeled data of the plurality of source domains input in the receiving.

4. A prediction system comprising a model learning device configured to learn a model predictor through supervised learning, and a prediction device configured to perform prediction of prediction target data using the model predictor,
wherein the model learning device includes
learning data input circuitry configured to receive an input of labeled data of a plurality of source domains, to which training data for the supervised learning belongs, relevant to a target domain to which the prediction target data of the model predictor belongs; and
learning circuitry configured to learn the model predictor using information unique to each domain in the labeled data of the plurality of source domains input by the learning data input circuitry, and
the prediction device includes
data input circuitry configured to receive an input of unlabeled data of the target domain;
prediction circuitry configured to output a supervised model suitable for the target domain using the model predictor learned by the learning circuitry and perform prediction of the unlabeled data of the target domain received by the data input circuitry using the supervised model; and
output circuitry configured to output a prediction result predicted by the prediction circuitry.
